(19) United States
(12) Patent Application Publication
(10) Pub. No.: US 2009/0132356 A1
(43) Pub. Date: May 21, 2009

(54) SYSTEM AND METHOD FOR PROFILE BASED ADVERTISEMENT INSERTION INTO CONTENT FOR SINGLE AND MULTI-USER SCENARIOS

(76) Inventors: Cory J. Booth, Beaverton, OR (US); Brian David Johnson, Portland, OR (US)

Correspondence Address: Molly A. McCall, Intel Corporation;Intel Corporation, c/o Intellevate, LLC, P.O. Box 52050, Minneapolis, MN, 55402, US

(21) Appl. No.: 11/942,178

(22) Filed: Nov. 19, 2007

(51) Int. Cl. G06Q 30/00

(52) U.S. Cl. 705/14

(57) ABSTRACT

A system and method for profile based advertisement insertion into content for single and multi-user scenarios are described. Various embodiments allow a content service or channel provider to sell advertising space not only when content is broadcast or downloaded but also when the content is shared or recommended. Here, the provider can continue to sell advertising in multiple media spaces as long as the content is connected to services of the provider. Other embodiments are described and claimed.

### BACKGROUND

The importance for a content service provider (e.g., a television service provider) to continuously strive to provide an increased variety of content and options to its subscribers cannot be overstated. No doubt this is one of the reasons why television service providers provide different types of services to their subscribers including on-demand pay-per-view programming, a variety of subscription options for broadcasted programs, subscriber-defined controls such as parental controls and cable modem Internet access.

But still, there are limitations to some of these types of services provided via the content service provider. For example, there are limitations to providing advertisements to a particular user along with requested content where the advertisements are tailored for the user. Often times the user is forced to watch or listen to advertisements that are of no interest to the user. In addition, advertising companies are paying for their advertisements to be broadcast along with the requested content and often not reaching the users that are likely to be most interested in their advertisements.

### BRIEF DESCRIPTION OF THE DRAWINGS

FIG. 1 illustrates one embodiment of a system.

FIG. 2 illustrates one embodiment of a logic flow.

FIG. 3 illustrates one embodiment of a logic flow.

FIG. 4 illustrates one embodiment of a logic flow.

FIG. 5 illustrates one embodiment of a system.

FIG. 6 illustrates one embodiment of a device.

### DETAILED DESCRIPTION

Various embodiments may be generally directed to a system and method for profiled based advertisement insertion into content for single and multi-user scenarios. Embodiments of the invention provide a way to send advertisements to a user along with requested content where the advertisements are tailored for the user. Other embodiments of the invention provide a way for the user to recommend that the requested content be shared with a second user where the requested content is updated with advertisements tailored for the second user before it is sent to the second user.

Various embodiments allow a content service or channel provider to sell advertising space not only when content is broadcast or downloaded but also when the content is shared or recommended. Here, the provider can continue to sell advertising in multiple media spaces as long as the content is connected to services of the provider. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

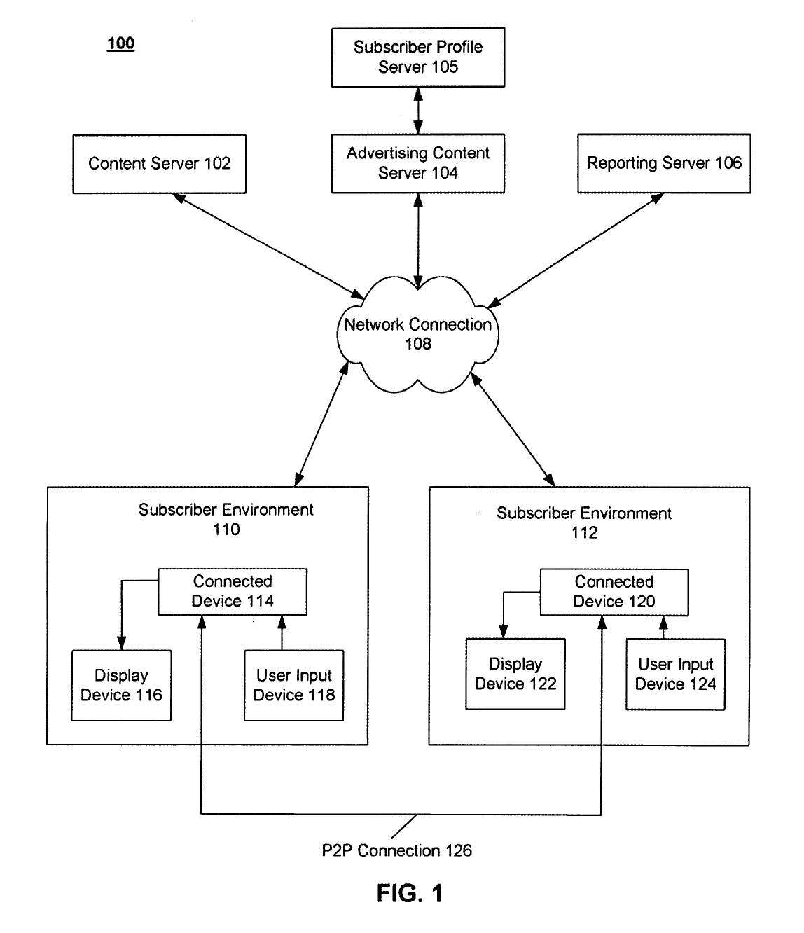

FIG. 1 illustrates an embodiment of a system 100. Referring to FIG. 1, system 100 may comprise a content server 102, an advertising content server 104, a subscriber profile server 105, a reporting server 106, a network connection 108, a subscriber environment 110, a subscriber environment 112 and a peer-to-peer (P2P) connection 126. Each of these elements is described next in more detail.

In embodiments, a content service provider (e.g., a television service provider) may host one or more of content server 102, advertising content server 104, subscriber profile server 105 and reporting server 106. In other embodiments, the content service provider may obtain some or all of the information provided via servers 102-106 from other sources.

For illustrations purposes only, embodiments of the present invention are described herein in terms of the content service provider being a television service provider and users being subscribers of the content service provider. It is important to note that embodiments of the present invention are not limited to facilitating television service providers in the controlled distribution of its content and customized advertisements. For example, the content service provider may also be a music service provider, a photograph service provider, or any company that wants to distribute controlled content and customized advertisements. In another embodiment of the invention, the content service provider described herein may be generic in the sense that no particular content service provider hosts the one or more servers. Here, multiple content service providers provide the necessary information to the generic server for the server to provide each of their subscriber's with controlled distribution of content and customized advertisements. In other embodiments, the necessary information for the controlled distribution of content and customized advertisements may be distributed among multiple devices such as televisions, personal computers, any mobile or ultra-mobile electronic device, and so forth. Furthermore, a subscriber may be any user of embodiments of the invention.

Content server 102 may store, but is not limited to, information about each of it subscribers and available content for each of its subscribers to download on demand. The distribution of the content is controlled because the content service provider hosts the content server where subscriber information is stored, the content service provider knows which content is included in a particular subscription with the content service provider and knows of subscriber-defined controls (e.g., parental controls) set up by the subscriber. Therefore, the content service provider, prior to allowing requested content to be distributed to the subscriber, can determine whether the subscriber has access rights to the requested content and whether the subscriber-defined controls allow for the content to be viewed.

Advertising content server 104 may store, but is not limited to, advertising content that may be inserted into content requested by a subscriber of the content service provider. Embodiments of server 104 may contain the functionality to match the stored advertising content to a particular subscriber's profile and to insert the matched advertising content into requested content prior to the requested content being forwarded to the subscriber.

Subscriber profile server 105 may store, but is not limited to, a profile for one or more subscribers of the content service provider. Here, in embodiments, information about a subscriber is stored in a profile. The profile may contain any information about the subscriber that may facilitate the content service provider in selecting advertising content that might be of interest to the subscriber (i.e., customizing the advertising content for the subscriber). Example types of profile information may include, but is not limited to, the types of content frequently requested by the subscriber, the general location of the subscriber, subscriber-provided preferences, and so forth. The profile information may or may not be encrypted. In other embodiments, information about a subscriber may be stored in an account, such as a cell phone account or cable television account, for example.

Reporting server 106 facilitates the tracking of when one or more subscribers access the requested content for viewing (and thus the inserted advertising content). Here, an activity report for the requested content and inserted advertising content may be collected by reporting server 106. The activity report may facilitate in the appropriate billing of an advertising company, for example, when it is determined that the inserted advertising content was likely to have been viewed or consumed by a subscriber. The activity report may also be used for statistical purposes (e.g., how often subscribers actually access content that they have requested, and so forth). In embodiments, subscribers are able to provide feedback about the requested content and/or inserted advertising content via the activity report. The activity report may or may not be encrypted.

Note that although the functionality of servers 102-106 is described herein as being separated into four components, this is not meant to limit the invention. In fact, this functionality may be combined into three or less components or separated into five or more components.

Servers 102-106 may communicate with user environments 110 and 112 via network connection 108. Network connection 108 may be a high speed Internet connection or any other type of connection suited for the particular application. Other types of connections may be added or substituted as new connections are developed.

When an individual becomes a subscriber of a content service provider (or any company, including but not limited to, a telecommunications company or cable company, for example), the individual generally provides identifying or personal information to the content service provider for billing purposes and so forth. Yet, embodiments of the invention allow the personal identity of the subscriber to remain anonymous within system 100. For example, in embodiments, elements or components in system 100 each have a unique internet protocol (IP) address and use this IP address to identify and communicate with each other via network connection 108. Generally, the linkage of an IP address to the subscriber's personal information (e.g., name, home address, etc.) is not publicly available information. Thus, through the use of IP addresses in system 100 to communicate, embodiments of the invention may maintain an anonymous nature. For example, subscribers of the content service provider may be identified in system 100 only via a unique IP address. Subscriber profiles in profile server 105 may be identified by the unique IP address. When requested content is accessed by a subscriber (known only via the IP address) and an activity report is generated and forwarded to reporting server 106, it may all be accomplished anonymously. Accordingly, in embodiments, information relating to the subscriber's profile, requested content, and accessed content is used anonymously in system 100.

In embodiments, subscriber environments 110 and 112 each include a connected device 114 and 120, respectively. Connected devices 114 and 120 are each owned, borrowed or licensed by their respective subscriber. Connected devices 114 and 120 are connected to network connection 108 and may communicate with servers 102-106 via their unique IP address, for example. As described above, connected devices 114 and 120 are identified by servers 102-106 via their unique IP address (and not by personal information of any subscriber). User environment 110 may also include a display device 116 and a user input device 118. Likewise, user environment 112 may include a display device 122 and a user input device 124.

In embodiments, connected devices 114 and 120 each represent a device that includes personal video recorder (PVR) functionality. PVR functionality records television data (i.e., requested content) in digital format (e.g., MPEG-1 or MPEG-2 formats) and stores the data in a hard drive or on a server, for example. The data may also be stored in a distributed manner such as on one or more connected devices throughout a home or office environment.

In the case of digital media streams, the PVR functionality routes the previously encoded digital media stream to local storage. PVR functionality of devices 114 and 120 may allow encoding of other types of data and other types of data may be added or substituted for those described as new types of data are developed.

In embodiments, connected devices 114 and 120 are connected to P2P connection 126 and thus may communicate with each other via connection 126 or connection 108. P2P connection 126 allows content to be shared among individuals where embodiments of the invention provide for a way to include advertisements tailored for each different individual when the content is shared.

Display devices 106 and 122 may each be a monitor, projector, a conventional analog television receiver, or any other kind of perceivable video display. The audio portion of the output of the connected devices may be routed through an amplifier, such as an audio/video (A/V) receiver or a sound processing engine, to headphones, speakers or any other type of sound generation device.

User input devices 118 and 124 may be any type of input device suited for a subscriber to communicate with connected devices 114 and 120, respectively.

Although only two subscriber environments are illustrated in FIG. 1, this is not meant to limit the invention. In fact, system 100 may include any number of subscriber environments.

In various embodiments, system 100 may be implemented as a wireless system, a wired system, or a combination of both. When implemented as a wireless system, system 100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Operations for the embodiments described herein may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments, however, are not limited to the elements or in the context shown or described in the figures.

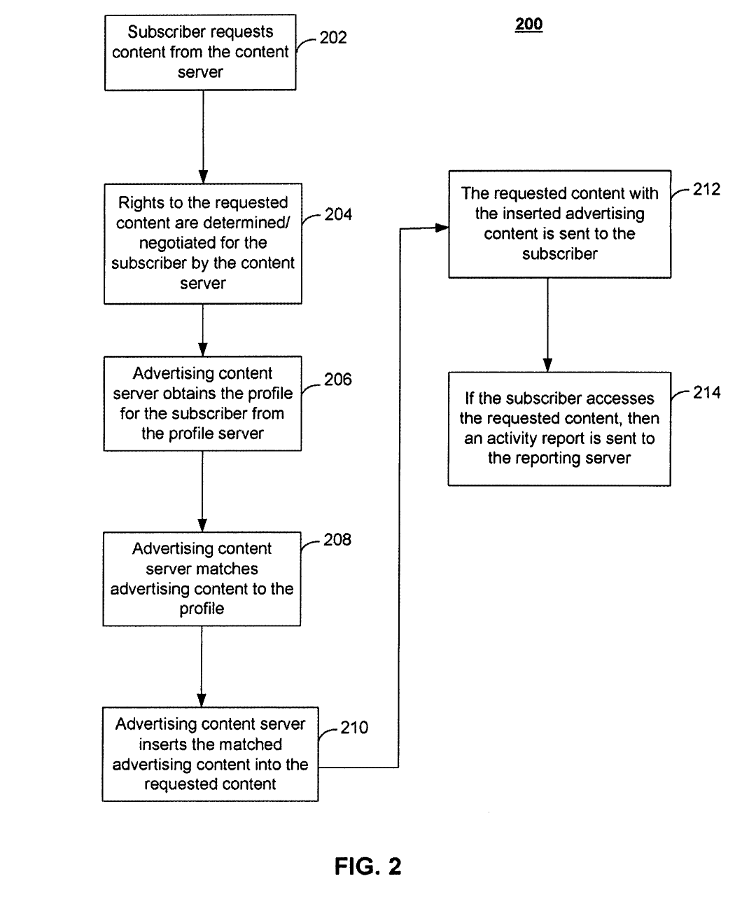

FIG. 2 illustrates one embodiment of a logic flow 200 illustrating a single user scenario. As shown in logic flow 200, a subscriber (such as connected device 114 from FIG. 1) requests content from a content server (such as content server 102) (block 202).

Rights to the requested content are determined/negotiated for the subscriber by the content server (block 204). For example, the content server might determine that the subscriber already has access rights to the requested content (e.g., the requested content is included in the subscriber's service agreement with the content service provider). Alternatively, if the subscriber does not have access rights to the requested content, then the content server might determine whether the requested content is a pay-per-view program. If so, then the subscriber is charged for the requested content prior to having access rights. The example is provided for illustration purposes only and is not meant to limit embodiments of the invention.

Once it is determined that the subscriber has access rights to the requested content, an advertising content server (such as server 104 of FIG. 1) obtains the profile for the subscriber from a profile server (such as server 105 of FIG. 1) (block 206). As discussed above, the subscriber profile may be anonymous. Here, the subscriber may be identified only via the unique IP address of his or her connected device or by some other anonymous means. Accordingly, the privacy and/or identity of an individual are not compromised by embodiments of the invention.

The advertising content server matches advertising content to the subscriber profile block 208). For example, if the profile indicates the general location of the subscriber, then advertising content may be selected for businesses in the same general location, and so forth. Another example may involve subscriber provided preferences in the profile. Here, advertising content that is similar to the subscriber preferences may be selected as a match. One example is if the subscriber likes to ski, then an advertisement from a travel agency promoting a trip to a popular ski resort might be selected as a match. There are limitless ways that embodiments of the invention might select matching advertising content for the subscriber.

The advertising content server inserts the matched advertising content into the requested content (block 210). The requested content with the inserted advertising content is sent to the subscriber (block 212). If the subscriber accesses the requested content, then an activity report is sent to the reporting server (such as reporting server 106 of FIG. 1) (block 214). As discussed above, embodiments of the invention provide an anonymous activity report to the reporting server such that it does not comprise the identity or privacy of the person associated with the subscriber or connected device.

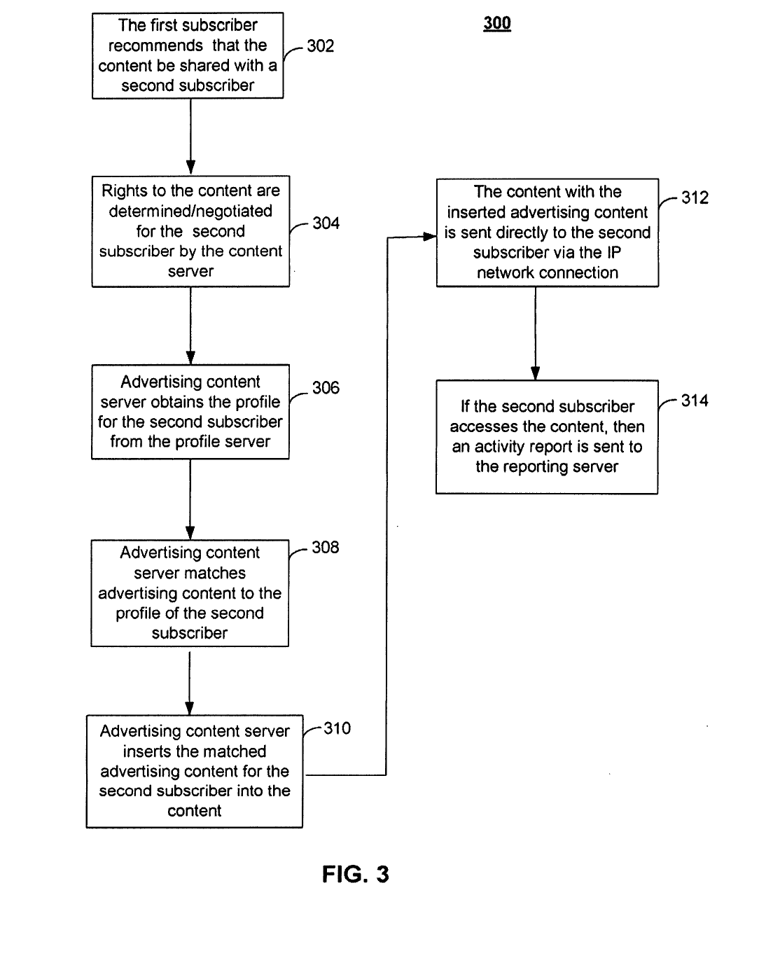

FIG. 3 illustrates one embodiment of a logic flow 300 illustrating a multi-user scenario. As shown in logic flow 300, a first subscriber recommends that content already acquired by the first subscriber via the content service provider be shared with a second subscriber (block 302). Rights to the content are determined/negotiated for the second subscriber by the content server (block 304). The second subscriber's rights to the content may be determined as described above with reference to block 204.

Once it is determined that the second subscriber has access rights to the content, the advertising content server obtains the profile for the second subscriber from the profile server (block 306). The operation of block 306 may be similar to block 206 as described above.

The advertising content server matches advertising content to the second subscriber profile (block 308). The operation of block 308 may be similar to block 208 as described above.

The advertising content server inserts the matched advertising content for the second subscriber into the content (block 310). The content with the inserted advertising content is sent directly to the second subscriber from the content service provider via the network connection (such as network connection 108 from FIG. 1) (block 312).

If the second subscriber accesses the content, then an activity report is sent to the reporting server (block 314). The operation of block 314 may be similar to block 214 as described above.

As described above, various embodiments allow a content service or channel provider to sell advertising space not only when content is broadcast or downloaded but also when the content is shared or recommended. Here, the provider can continue to sell advertising in multiple media spaces as long as the content is connected to services of the provider. The activity report provides a sort of proof that the advertising content was accessed or viewed.

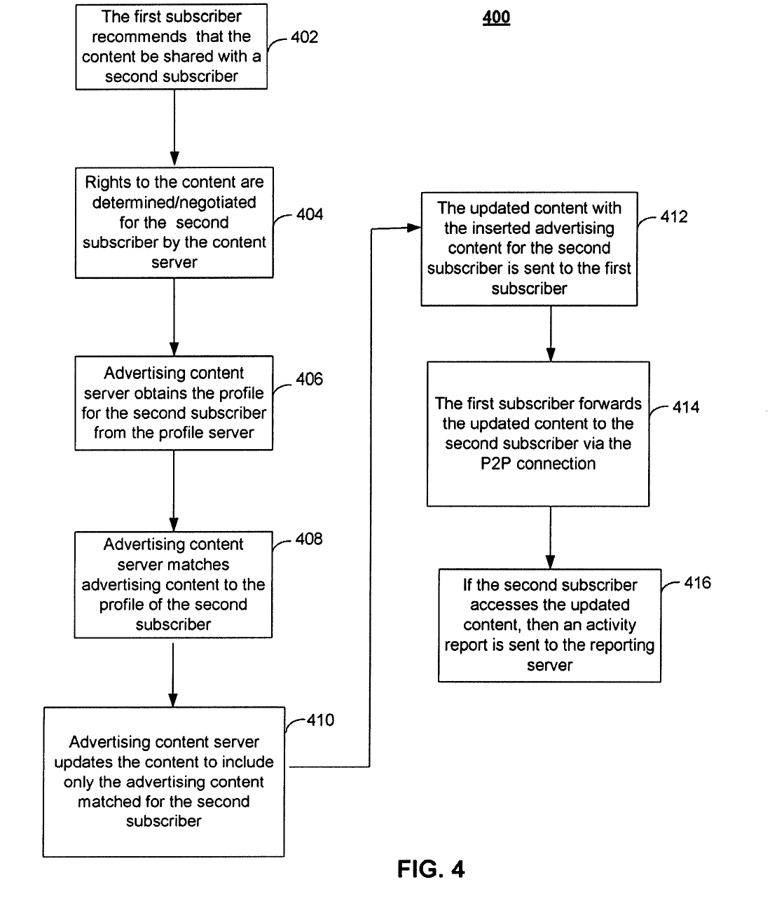

FIG. 4 illustrates a second embodiment of a logic flow 400 illustrating a multi-user scenario. As shown in logic flow 400, blocks 402 through 408 are similar to those discussed above with reference to blocks 302 through 308 of FIG. 3.

The advertising content server updates the content to include only the advertising content matched for the second subscriber (block 410). In embodiments, the second subscriber does not receive the same advertising content sent to the first subscriber. The updated content is sent to the first subscriber (block 412). The updated content is sent to the second subscriber from the first subscriber via a P2P connection (such as connection 126 of FIG. 1) (block 414).

If the second subscriber accesses the updated content, then an activity report is sent to the reporting server (block 416). The operation of block 416 may be similar to block 314 as described above.

The embodiments, however, are not limited to the elements or in the context shown or described in FIGS. 2-4. For example, a first user is not limited to recommending that the requested content be sent to only one other subscriber. In fact, a first subscriber may make the recommendation at the same time to send the requested content to multiple subscribers. In embodiments, a subscriber who receives content as the result of another subscriber making a recommendation may make a recommendation to send it to yet. another subscriber, and so forth.

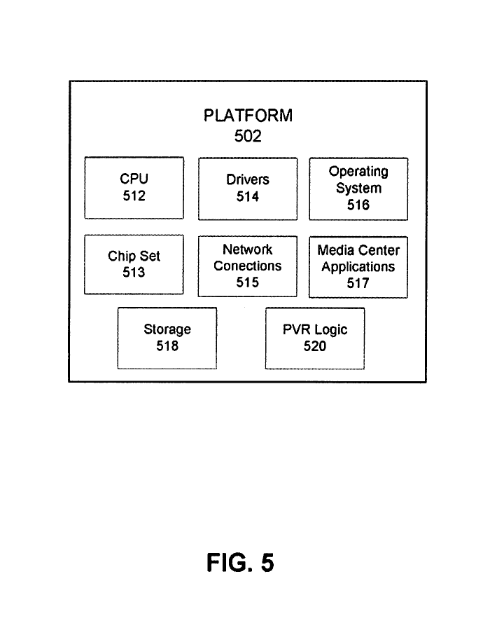

FIG. 5 illustrates an embodiment of a platform 502 (e.g., connected devices 114 or 120 from FIG. 1). In one embodiment, platform 502 may comprise or may be implemented as a media platform 502 such as the Viiv™ media platform made by Intel® Corporation. In one embodiment, platform 502 may interact with one or more servers of a content service provider (such as servers 102-106 via network connection 108 from FIG. 1) and with other user environments (such as user environments 110 or 112 via P2P connection 126 from FIG. 1).

In one embodiment, platform 502 may comprise a CPU 512, a chip set 513, one or more drivers 514, one or more network connections 515, an operating system 516, and/or one or more media center applications 517 comprising one or more software applications, for example. Platform 502 also may comprise storage 518.

In one embodiment, CPU 512 may comprise one or more processors such as dual-core processors. Examples of dual-core processors include the Pentium® D processor and the Pentium® processor Extreme Edition both made by Intel® Corporation, which may be referred to as the Intel Core Duo® processors, for example.

In one embodiment, chip set 513 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 514 may comprise the Quick Resume Technology Drivers made by Intel® to enable users to instantly turn on and off platform 502 like a television with the touch of a button after initial boot-up, when enabled, for example. In addition, chip set 513 may comprise hardware and/or software support for 5.1 surround sound audio and/or high definition 7.1 surround sound audio, for example. Drivers 514 may include a graphics driver for integrated graphics platforms. In one embodiment, the graphics driver may comprise a peripheral component interconnect (PCI) Express graphics card.

In one embodiment, network connections 515 may comprise the PRO/1000 PM or PRO/100 VE/VM network connection, both made by Intel® Corporation.

In one embodiment, operating system 516 may comprise the Windows® XP Media Center made by Microsoft® Corporation. In one embodiment, one or more media center applications 517 may comprise a media shell to enable users to interact with a remote control from a distance of about 10-feet away from platform 502 or a display device, for example. in one embodiment, the media shell may be referred to as a “10-feet user interface,” for example. In addition, one or more media center applications 517 may comprise the Quick Resume Technology made by Intel®, which allows instant on/off functionality and may allow platform 502 to stream content to media adaptors when the platform is turned “off.”

In one embodiment, storage 518 may comprise the Matrix Storage technology made by Intel® to increase the storage performance enhanced protection for valuable digital media when multiple hard drives are included. In one embodiment, PVR logic 520 is used to enable the functionality of the invention as described herein. The embodiments, however, are not limited to the elements or in the context shown or described in FIG. 5.

Platform 510 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

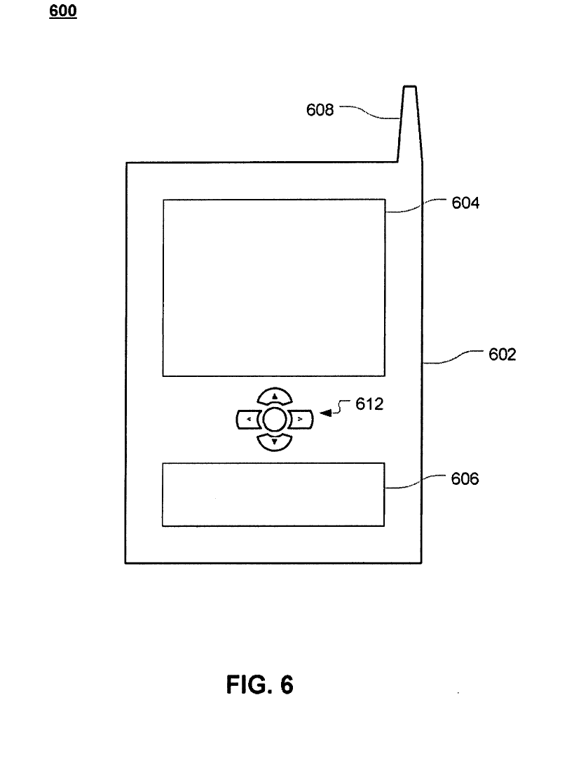

FIG. 6 illustrates one embodiment of a device 600 in which functionality of the present invention as described herein may be implemented. In one embodiment, for example, device 600 may comprise a communication system. In various embodiments, device 600 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 600 may be implemented as part of a wired communication system, a wireless communication system, or a combination of both. In one embodiment, for example, device 600 may be implemented as a mobile computing device having wireless capabilities. A mobile computing device may refer to any device having a processing system and a mobile power source or supply, such as one or more batteries, for example.

Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth.

In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise a five-way navigation button 612. I/O device 606 may comprise a suitable keyboard, a microphone, and/or a speaker, for example. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, voice recognition device and software, and so forth. Information also may be entered into device 600 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
requesting content from a content server by a user;
receiving the requested content with advertising content inserted in the requested content, wherein the advertising content is based on a profile of the user; and
sending an acknowledgement when the requested content with the inserted advertising content has been accessed.

2. The method of claim 1, wherein the user is known only via a unique Internet Protocol (IP) address.

3. The method of claim 1, further comprising:
recommending to the content server that the requested content be shared with a second user, wherein the requested content with updated content based on a profile of the second user is sent directly to the second user via an Internet Protocol (IP) connection.

4. The method of claim 1, further comprising:
recommending to the content server that the requested content be shared with a second user;
receiving the requested content with updated advertising content, wherein the updated advertising content is based on a profile of the second user, and
sending the requested content with the updated advertising content to the second user.

5. The method of claim 4, wherein sending the requested content with the updated advertising content to the second user comprises the user sending the requested content with the updated advertising content to the second user via a peer-to-peer (P2P) connection.

6. The method of claim 4, wherein the user and the second user are known only via unique Internet Protocol (IP) addresses.

7. The method of claim 1, wherein the acknowledgement is used to bill an advertising company of the inserted advertising content.

8. A system, comprising:
a device connected to a network, wherein a user of the device to request content from a content server, wherein the device to receive the requested content with advertising content inserted in the requested content, wherein the advertising content is based on a profile of the user, and wherein when the requested content with the advertising content inserted is accessed an acknowledgement is sent.

9. The system of claim 8, wherein the user is known only via a unique Internet Protocol (IP) address of the device.

10. The system of claim 8, wherein the user to recommend to the content server that the requested content be shared with a second user, wherein the requested content with updated content based on a profile of the second user is sent directly to the second user via an Internet Protocol (IP) connection.

11. The system of claim 8, wherein the user to recommend to the content server that the requested content be shared with a second user, wherein the device to receive the requested content with updated advertising content, wherein the updated advertising content is based on a profile of the second user, and wherein the device to send the requested content with updated advertising content to the second user.

12. The system of claim 11, wherein sending the requested content with the updated advertising content to the second user comprises the device sending the requested content with the updated advertising content to the second user via a peer-to-peer (P2P) connection.

13. The system of claim 11, wherein the user is known only via a unique Internet Protocol (IP) address of the device and wherein the second user is known only via a unique IP address of a second device.

14. The system of claim 8, wherein the acknowledgement is used to bill an advertising company of the inserted advertising content.

15. A machine-readable storage medium containing instructions which, when executed by a processing system, cause the processing system to perform a method, the method comprising:
requesting content from a content server by a user;
receiving the requested content with advertising content inserted in the requested content, wherein the advertising content is based on a profile of the user; and
sending an acknowledgement when the requested content with the inserted advertising content has been accessed.

16. The machine-readable storage medium of claim 15, wherein the user is known only via a unique Internet Protocol (IP) address.

17. The machine-readable storage medium of claim 15, further comprising:
recommending to the content server that the requested content be shared with a second user, wherein the requested content with updated content based on a profile of the second user is sent directly to the second user via an Internet Protocol (IP) connection.

18. The machine-readable storage medium of claim 15, further comprising:
recommending to the content server that the requested content be shared with a second user;
receiving the requested content with updated advertising content, wherein the updated advertising content is based on a profile of the second user; and
sending the requested content with the updated advertising content to the second user.

19. The machine-readable storage medium of claim 18, wherein sending the requested content with the updated advertising content to the second user comprises the user sending the requested content with the updated advertising content to the second user via a peer-to-peer (P2P) connection.

20. The machine-readable storage medium of claim 18, wherein the user and the second user are known only via unique Internet Protocol (IP) addresses.
